(19) United States
(12) Patent Application Publication
(10) Pub. No.: US 2025/0274397 A1
(43) Pub. Date: Aug. 28, 2025

(54) SEAMLESS PACKET ORDERING FUNCTION (POF) FOR TIME-SENSITIVE NETWORK (TSN) NODE

(71) Applicant: TELEFONAKTIEBOLAGET LM ERICSSON (PUBL), Stockholm (SE)

(72) Inventors: Balázs VARGA, BUDAPSEST (HU); Ferenc FEJES, BUDAPSEST (HU); János FARKAS, KECSKEMÉT (HU); Gyõrgy MIKLÖS, PILISBOROSJENÖ (HU)

(73) Assignee: TELEFONAKTIEBOLAGET LM ERICSSON (PUBL), Stockholm (SE)

(21) Appl. No.: 18/859,554

(22) PCT Filed: May 3, 2023
(86) PCT No.: PCT/IB2023/054606

§ 371 Date: Oct. 24, 2024

Related U.S. Application Data
(60) Provisional application No. 63/342,253, filed on May 16, 2022.

(51) Int. Cl. H04L 47/34; H04L 47/28; H04L 47/32

(52) U.S. Cl. CPC H04L 47/34; H04L 47/28; H04L 47/32

(57) ABSTRACT

Embodiments include methods performed by one or more instances of a packet ordering function (POF) for a time-sensitive network (TSN) node configured for frame replication and elimination for reliability (FRER). Such methods include receiving, from a packet elimination function (PEF) of the TSN node, a stream of packets created by the PEF from a plurality of member streams received from a transmitting TSN node. Such methods include, based on detecting a reset flag in a first packet of the received packets, performing one of the following operations before buffering and forwarding the first packet and subsequently received packets: reinitializing a first POF instance that was buffering and forwarding packets received before the first packet, or switching (862) from the first POF instance to a second POF instance for buffering and forwarding the first packet and subsequently received packets. Other embodiments include TSN nodes configured to perform such methods.

### TECHNICAL FIELD

The present disclosure relates generally to the field of wireless networks and more specifically to techniques that improve reliability of time-sensitive networks (TSN) by ensuring that received packets can be reordered correctly, even after a reset event in a transmitting TSN node causes a discontinuity in packet sequence numbers.

### BACKGROUND

Industry 4.0 is a term used to refer to a current trend of automation and data exchange in manufacturing. It can include concepts and/or technologies such as cyber-physical systems, the Internet of things (IoT), cloud computing, and cognitive computing. Industry 4.0 is also referred to as the fourth industrial revolution or “14.0” for short. One scenario or use case for Industry 4.0 is the so-called “smart factory,” which is also referred to as Industrial Internet of Things (IIoT).

There are four common principles associated with Industry 4.0. First, “interoperability” requires the ability to connect machines, devices, sensors, and people to communicate with each other via the Internet of Things (IoT) or the Internet of People (IoP). Second, “information transparency” requires information systems to have the ability to create a virtual copy of the physical world by enriching digital models (e.g., of a smart factory) actual with sensor data. For example, this can require the ability to aggregate raw sensor data to higher-value context information.

Third, “technical assistance” requires assistance systems to be able to support humans by aggregating and visualizing information comprehensively for making informed decisions and solving urgent problems on short notice. This principle can also refer to the ability of cyber physical systems to physically support humans by conducting a range of tasks that are unpleasant, too exhausting, or unsafe for their human co-workers. Finally, cyber physical systems should have the ability to make decentralized decisions and to perform their tasks as autonomously as possible. In other words, only in the case of exceptions, interferences, or conflicting goals, should tasks be delegated to a higher level.

These principles associated with Industry 4.0 support various use cases that place many requirements on a network infrastructure. Simpler use cases include plant measurement while more complex use cases include precise motion control in a robotized factory cell. To address these requirements, the IEEE 802.1 working group (particularly, task group TSN) has developed a Time Sensitive Networking (TSN) standard. TSN is based on the IEEE 802.3 Ethernet standard, a Layer-2 protocol that is designed for “best effort” quality of service (QoS). TSN describes a collection of features intended to make legacy Ethernet performance more deterministic, including time synchronization, guaranteed low-latency transmissions, and improved reliability. The TSN features available today can be grouped into the following categories (shown below with associated IEEE specifications):
Time Synchronization (e.g., IEEE 802.1AS);
Bounded Low Latency (e.g., IEEE 802.1Qav, IEEE 802.1Qbu, IEEE 802.1Qbv, IEEE 802.1Qch, IEEE 802.1Qcr);
Ultra-Reliability (e.g., IEEE 802.1CB, IEEE 802.1Qca, IEEE 802.1Qci);
Network Configuration and Management (e.g., IEEE 802.1Qat, IEEE 802.1Qcc, IEEE 802.1Qcp, IEEE 802.1CS).

802.1CB specifies a technique called Frame Replication and Elimination for Reliability (FRER) that is intended to avoid frame loss due to equipment failure. FRER divides a Stream into one or more linked Member Streams, thus making the original Stream a Compound Stream. It replicates packets of the Stream, splitting the replica packets into the multiple Member Streams. FRER then rejoins those Member Streams at one or more other points (e.g., receiver), eliminates the replica (or duplicate) packets, and delivers the reconstituted Stream from those points. Although FRER provides redundancy over maximally disjoint paths, it does not include failure detection and/or switchover.

Deterministic Networking (DetNet) is an effort by the Internet Engineering Task Force (IETF) towards specifying deterministic data paths for real-time applications with extremely low data loss rates, packet delay variation (jitter), and bounded latency, such as audio and video streaming, industrial automation, and vehicle control. DetNet operates at the Internet Protocol (IP) layer (i.e., Layer 3) using a Software-Defined Networking (SDN) layer to provide Integrated Services (IntServ) and Differentiated Services (DiffServ) integration. Moreover, DetNet is intended to deliver services over Layer 2 technologies such as multi-protocol label switching (MPLS) and IEEE 802.1 TSN.

DetNet includes a function similar to FRER, called Packet Replication and Elimination Function (PREF). PREF is defined to simplify implementation by facilitating use of the same approach in both Layer-2 (TSN) and Layer-3 (DetNet) networks. In practice, IEEE 802.1CB provides implementation guidelines for IETF DetNet PREF.

### SUMMARY

Both IEEE and IETF have identified that DetNet PREF may cause out-of-order delivery of frames/packets. Correcting frame/packet order is a difficult task, and DetNet WG has specified the expected result of a Packet Ordering Function (POF) but not how the POF should accomplish that result. Furthermore, in conventional packet networks, packet reordering is handled at higher OSI layers (e.g., TCP for application-layer packets). In contrast, a POF to be used with PREF must operate at lower layers, such as Layer-2 (TSN) and Layer-3 (DetNet). Thus, new solutions for packet reordering are needed.

An object of embodiments of the present disclosure is to improve reliability of TSN, such as by providing and/or facilitating solutions to overcome exemplary problems summarized above and described in more detail below.

Embodiments include various methods (e.g., procedures) performed by one or more instances of a POF for a TSN node configured for FRER.

These exemplary methods can include receiving, from a packet elimination function (PEF) of the TSN node, a stream of packets created by the PEF from a plurality of member streams received from a transmitting TSN node. These exemplary methods also include, based on detecting a reset flag in a first packet of the received packets, performing one of the following first operations prior to buffering and forwarding the first packet and subsequently received packets:
reinitializing a first POF instance that was buffering and forwarding packets received before the first packet, or
switching from the first POF instance to a second POF instance for buffering and forwarding the first packet and subsequently received packets.

In some embodiments, these exemplary methods can also include forwarding all buffered packets received before the first packet, in an order corresponding to respective sequence numbers included in the buffered packets. Also, these exemplary methods can include, based on performing one of the first operations, buffering the first packet and subsequently received packets and forwarding these buffered packets in the order corresponding to respective sequence numbers included in the buffered packets.

In some of these embodiments, reinitializing the first POF instance comprises starting a timer associated with the first POF instance upon detecting the reset flag in the first packet. In such case, buffering the first packet and subsequently received packets is performed while the timer is running and forwarding the first packet and subsequently received packets is performed upon expiration of the timer.

In other of these embodiments, switching from the first POF instance to the second POF comprises starting a timer associated with the second POF instance upon detecting the reset flag in the first packet. In such case, buffering the first packet and subsequently received packets is performed while the timer is running, and forwarding the first packet and subsequently received packets is performed upon expiration of the timer.

In some embodiments, the detected reset flag indicates a reset event in a sequence number generation function of the transmitting TSN node. In some embodiments, these exemplary methods can also include maintaining a current value for a highest sequence number contained in the received packets.

In some of these embodiments, these exemplary methods can also include receiving from the PEF an indication of a history window used by the PEF for creating the stream from the member streams, and calculating a reset ignore range (RiR) based on the history window used by the PEF and the current value for the highest sequence number. In such case, performing one of the first operations is further based on a sequence number of the first packet being outside of the RiR. In some variants of these embodiments, the current value for the highest sequence number is greater than the sequence number of the first packet.

In some variants of these embodiments, the first operation performed is switching from the first POF instance to the second POF instance, the second operations are performed by the second POF instance, and the reset flag is detected by the second POF instance. In some further variants, the first POF instance utilizes a circular sequence number space for the order of the forwarding and the second POF instance utilizes a linear sequence number space for the order of the forwarding.

In some further variants, these exemplary methods can also include, after switching from the first POF instance to the second POF instance, upon detecting that a sequence number of a received packet is in a range defined by first and second limits, switching to the first POF instance for subsequent buffering and forwarding of the buffered packets. For example, the first limit is a first integer multiple of a history window used by the PEF for creating the stream from the member streams, and the second limit is a second integer multiple of the history window. As a more specific example, the first integer is one and the second integer is two.

In other variants of these embodiments, the first operation performed is reinitializing the first POF instance, the second operations are performed by the first POF instance, and the reset flag is detected by the first POF instance. In some further variants, the first POF instance utilizes a circular sequence number space for the order of forwarding.

Other embodiments include TSN nodes configured to perform operations corresponding to any of the exemplary methods described herein. Other embodiments include non-transitory, computer-readable media storing program instructions that, when executed by processing circuitry, configure such TSN nodes to perform operations corresponding to any of the exemplary methods described herein.

These and other embodiments described herein can ensure packet reordering (e.g., by a POF) works correctly in TSN/DetNet deployments in which seamless FRER/PREF functionality is also used, even after reset of a packet sequence number generator in a transmitting TSN node. In this manner, embodiments increase reliability of deployed TSN/DetNets.

These and other objects, features, and advantages of embodiments of the present disclosure will become apparent upon reading the following Detailed Description in view of the Drawings briefly summarized below.

### BRIEF DESCRIPTION OF THE DRAWINGS

FIG. 1 is a block diagram illustrating an exemplary arrangement for interworking between a 5G network and an exemplary TSN network.

FIG. 2 shows an example TSN arrangement that employs 802.1CB FRER.

FIG. 3 is a block diagram of a TSN node according to various embodiments of the present disclosure.

FIG. 4 is a state diagram depicting a POF initialization state (TakeAny) and a POF processing state.

FIG. 5 is a block diagram of a TSN node according to various embodiments of the present disclosure.

FIG. 6 illustrates a single POF instance that utilizes a circular sequence number space for order of packet forwarding, according to some embodiments of the present disclosure.

FIG. 7 illustrates two POF instances with separate sequence number spaces—one circular and one linear—for order of packet forwarding, according to other embodiments of the present disclosure.

FIG. 8 shows a flow diagram illustrating an exemplary method (e.g., procedure) performed by one or more instances of a POF for a TSN node configured for FRER, according to various embodiments of the present disclosure.

FIG. 9 shows a communication system according to various embodiments of the present disclosure.

FIG. 10 shows a UE according to various embodiments of the present disclosure.

FIG. 11 shows a network node according to various embodiments of the present disclosure.

FIG. 12 shows host computing system according to various embodiments of the present disclosure.

FIG. 13 is a block diagram of a virtualization environment in which functions implemented by some embodiments of the present disclosure may be virtualized.

FIG. 14 illustrates communication between a host computing system, a network node, and a UE via multiple connections, according to various embodiments of the present disclosure.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

In general, all terms used herein are to be interpreted according to their ordinary meaning to a person of ordinary skill in the relevant technical field, unless a different meaning is expressly defined and/or implied from the context of use. All references to a/an/the element, apparatus, component, means, step, etc. are to be interpreted openly as referring to at least one instance of the element, apparatus, component, means, step, etc., unless explicitly stated otherwise or clearly implied from the context of use. The operations of any methods and/or procedures disclosed herein do not have to be performed in the exact order disclosed, unless an operation is explicitly described as following or preceding another operation and/or where it is implicit that an operation must follow or precede another operation. Any feature of any embodiment disclosed herein can apply to any other disclosed embodiment, as appropriate. Likewise, any advantage of any embodiment described herein can apply to any other disclosed embodiment, as appropriate.

Currently the fifth generation (5G) of cellular systems, also referred to as New Radio (NR), is being standardized within the Third-Generation Partnership Project (3GPP). NR is developed for maximum flexibility to support many different use cases. These include mobile broadband, machine type communication (MTC), ultra-reliable low-latency communications (URLLC), device-to-device (D2D), etc. The achievable latency and reliability performance of NR are important for these and other use cases related to IIoT and/or Industry 4.0. In order to extend NR applicability for such use cases, support for time synchronization in the 5G system via time sensitive network (TSN) has been defined in 3GPP TS 23.501 (v18.4.0).

At a high level, the 5G network architecture consists of a Next Generation radio access network (NG-RAN) and a 5G core network (5GC). The NG-RAN includes various gNodeB's (gNBs, also referred to as base stations) serving cells by which wireless devices (also referred to as user equipment, or UEs) communicate. The gNBs can be connected to the 5GC via one or more NG interfaces and to each other via Xn interfaces. Each of the gNBs can support frequency division duplexing (FDD), time division duplexing (TDD), or a combination thereof.

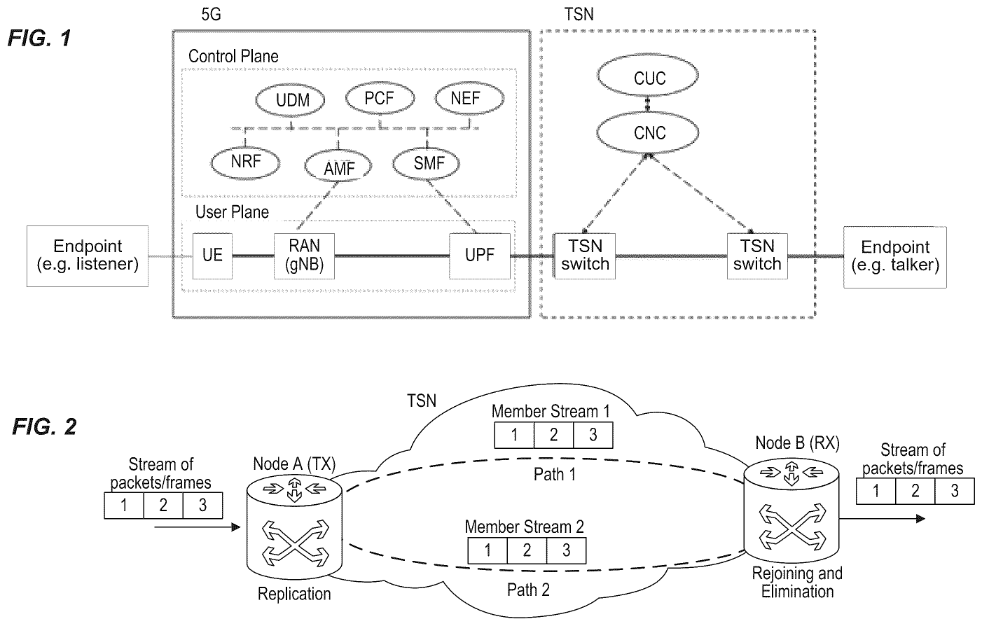

To support IIoT uses cases, a 5G network (e.g., NG-RAN and 5GC) should deliver highly accurate timing information from an external TSN network to TSN endpoints connected to the 5G network, e.g., via UEs. FIG. 1 is a block diagram illustrating an exemplary arrangement for interworking between a 5G network and an exemplary TSN network. In the following discussion, a device connected to the 5G network is referred to as 5G endpoint, and a device connected to the TSN domain is referred to as TSN endpoint. The arrangement shown in FIG. 1 includes a Talker TSN endpoint and a Listener 5G endpoint connected to a UE. In other arrangements, a UE can instead be connected to a TSN network comprising at least one TSN bridge and at least one TSN endpoint. In this configuration, the UE can be part of a TSN-5G gateway.

The TSN can include a grandmaster clock (TSN GM) that serves as the definitive timing source for TSN endpoints. At a high level, the 5G network in FIG. 1 should appear to the connected TSN as a switch or bridge that delivers the TSN GM timing to the connected endpoints in compliance with the requirements in IEEE 802.1AS. However, the 5G network does not use the TSN GM as its own timing source, but instead relies on a 5G system clock (5GSC) that is distributed among the various network nodes or functions. As such, one or more timing relationships between TSN GM and 5GSC may need to be determined and/or derived to facilitate transit of the TSN GSM to the connected end station in a compliant manner.

At a high level, the time synchronization illustrated in FIG. 1 requires NG-RAN nodes (e.g., gNBs) to be synchronized to the 5G network reference time (i.e., based on 5GSC) while TSN GM timing is delivered to UEs and endpoints transparently through the 5G network using higher-layer generalized precision time protocol (gPTP) signaling. For 5GSC synchronization, a UE relies on its serving gNB providing reference time periodically, either via broadcast or unicast signaling. The nominal periodicity Tn of gNB reference time delivery is left to network implementation. However, Tn can reflect the UE clock stability and gNB clock stability in relation to the 5G GM clock used as the basis of the 5G reference time, etc.

The following description uses IEEE 802.1CB terminology and variable names where appropriate, denoted as “VariableName”. Some embodiments of the present disclosure include additional variables, functions, and/or parameters related to new features for IEEE 802.1CB and follow the same naming conventions.

As briefly mentioned above, 802.1CB specifies a Frame Replication and Elimination for Reliability (FRER) technique that is intended to avoid frame loss due to equipment failure in TSN. FRER divides a Stream into one or more linked Member Streams, thus making the original Stream a Compound Stream. It replicates packets of the Stream, splitting the replica packets into the multiple Member Streams. FRER then rejoins those Member Streams at one or more other points (e.g., receiver), eliminates the replica (or duplicate) packets, and delivers the reconstituted Stream from those points.

FIG. 2 shows an example TSN arrangement that employs 802.1CB FRER. In this exemplary arrangement, a stream of packets (or frames) arrives at node A, which divides the stream into member streams 1 and 2. Node A replicates packets 1-3 to be carried on both member streams and transmits these member streams over maximally disjoint paths 1 and 2 to node B. This node rejoins member streams 1 and 2 and eliminates any duplicate packets received. In case there is blockage or outage on either of paths 1-2, the member stream carried on the other path will still be received by node B.

In IETF the Deterministic Networking (DetNet) Working Group (WG) focuses on deterministic data paths that can provide bounds on latency, loss, and packet delay variation (jitter), and high reliability. DetNet WG addresses layer-3 methods in support of applications that require deterministic networking. For example, DetNet WG focuses on aspects required to enable a multi-hop path, and forwarding along the path, with the deterministic properties of controlled latency, low packet loss, low packet delay variation, and high reliability. Layer 3 data plane technologies that can be used in DetNet networks include IP and MPLS.

DetNet WG has also defined a packet replication function (PRF) and a packet elimination function (PEF) for achieving extreme low packet loss. These functions are intended to simplify implementation and facilitate use of the same approach in both Layer-2 (TSN) and Layer-3 (DetNet) networks. These functions together are called Packet Replication and Elimination Function (PREF). In practice, IEEE 802.1CB provides implementation guidelines for IETF DetNet PREF.

As briefly mentioned above, both IEEE and IETF have identified that DetNet PREF may cause out-of-order delivery of frames/packets. Correcting frame/packet order is a difficult task, and DetNet WG has specified the expected result of a Packet Ordering Function (POF), i.e., that packets should be correctly reordered. However, DetNet WG has not specified how POF should accomplish that expected result. IEEE 802.1 TSN TG has not yet defined such a functionality; it is not mentioned in IEEE 802.1CB-2017 except for a statement that it is outside of 802.1CB-2017 scope.

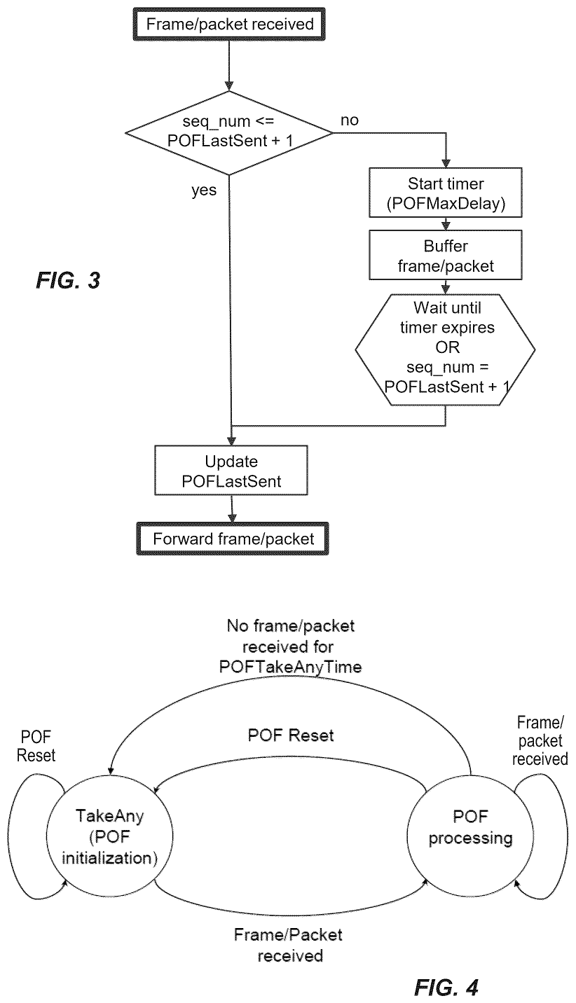

Furthermore, in conventional packet networks, packet reordering is handled at higher OSI layers (e.g., TCP for application-layer packets). In contrast, a POF to be used with PREF must operate at lower layers, such as Layer-2 (TSN) and Layer-3 (DetNet). Application PCT/SE2021/051201 (published as WO2022/139656A1) by Applicant discloses various POF embodiments that can be used for TSN/DetNet. FIG. 3 is a flowchart depicting operations of one of these POF embodiments. POF is downstream of a PEF, either in the same TSN node or in another downstream TSN node.

Initially, a packet is received by the POF. A sequence number (seq_num) of the newly received packet is compared to a stored value of the last packet forwarded by the POF (POFLastSent). If the newly received packet is an earlier or the “next” packet in the stream—that is, if seq_num≤ POFLastSent+1—then the “yes” path of the flowchart is followed. The value of POFLastSent is updated (POFLastSent=seq_num), and the newly received packet is forwarded. However, if the newly received packet is further ahead in the packet stream than being “next” to the last packet forwarded—that is, if seq_num>POFLastSent+1—then the “no” path of the flowchart is followed. A timer is started, having a value of a predetermined maximum buffering time (POFMaxDelay), and the newly received packet is buffered.

Other received packets are processed and the value of POFLastSent is updated as they are forwarded. When seq_num=POFLastSent+1, the buffered packet is the “next” packet, and is retrieved from the buffer and forwarded. Alternatively, if the POFMaxDelay timer expires, the packet is also retrieved from the buffer, regardless of its seq_num. In either case, the value of POFLastSent is updated (POFLastSent=seq_num), and the packet retrieved from the buffer is forwarded.

Note that the sequence number comparison operation seq_num≤POFLastSent+1 is not necessarily mathematical, but may account for discontinuities due to a circular sequence number space. In some embodiments, the difference of sequence numbers in consecutive packets in a stream is bounded due to the History window of the Elimination function upstream of the POF.

The flowchart of FIG. 3, and the above description of operation of the POF, assume the POF is ongoing, in which case the value of POFLastSent is the sequence number of the last packet forwarded in a packet stream. This value must be initialized. FIG. 4 is a state diagram depicting a POF initialization state (TakeAny) and a POF processing state. In the POF initialization state, the value of POFLastSent is set to the sequence number of the first packet received, and that packet is immediately forwarded. The receipt of a packet (and initialization of POFLastSent) triggers a transition to the POF processing state, where updating of POFLastSent occurs as described above and with reference to FIG. 3.

The POF transitions from the POF processing state to the POF initialization state upon a POF reset (e.g., triggered by a hardware signal, or by a higher layer function or application). An asserted POF reset signal or command will maintain the POF in the POF initialization state, regardless of the receipt of packets. In the POF initialization state, all buffers are flushed and the value of POFLastSent is cleared. In one embodiment, the POF will additionally transition from the POF processing state to the POF initialization state if no packet for a packet stream is received for a predetermined duration (POFTakeAnyTime). The value of POFTakeAnyTime may be calculated based on several factors, for example the RECOVERY_TIMEOUT related settings of the Elimination function(s) upstream of the POF, the packet stream characteristics (e.g., inter packet time), and the latency difference of the paths used by the packet stream.

The POF embodiments described above with reference to FIG. 3 do not appreciably delay packets received in sequence number order, and increases the latency of packets received out-of-order by a maximum duration of POFMaxDelay. This POF is effective for all network scenarios where the remaining delay budget of a packet stream at the POF point is larger than POFMaxDelay.

Publications WO2021/005397A1, WO2021/005400A1, and WO2021/0118910A1 by Applicant disclose other improvements to the 802.1CB(-2017) FRER. For example, these improvements target scenarios in which frames are dropped unnecessarily by 802.1CB FRER due to reset of the sequence number generation function. The disclosed improvements facilitate cloud-based deployment of 802.1CB FRER by providing seamless reset for sequence number generation, which enables faster and seamless adaptation to network failure scenarios and protects again unnecessary packet drops when sequence generation is reset.

Applicants have recognized that the POF solutions disclosed in PCT/SE2021/051201 may have some problems, issues, and/or difficulties when combined with the seamless FRER improvements disclosed in WO2021/005397A1, WO2021/005400A1, and WO2021/0118910A1. For example, these improvements introduce a bounded latency, which is a new requirement that a corresponding POF solution must consider. Accordingly, some new POF solutions for TSN/DetNet are needed.

Embodiments of the present disclosure address these and other problems, issues, and/or difficulties by providing packet processing rules for a POF and the use of multiple POF instances when multiple sequence number spaces are implemented. In some embodiments, POF can use available “ResetFlag” information during a re-ordering process. In some embodiments, POF can be replicated (e.g., into multiple instances) to support multiple sequence number spaces, providing re-ordering on a per sequence-number space basis. To support these features, POF can be provided some configuration parameters (e.g., history-window size) used by DetNet PEF to facilitate POF adaptation to sequence number changes caused by the reset of the sequence number generation function.

Embodiments can provide various benefits and/or advantages. For example, embodiments can ensure packet ordering (e.g., by POF) works correctly in TSN/DetNet deployments in which seamless FRER/PREF functionality is also used, even after reset of a packet sequence number generator in a transmitting TSN node.

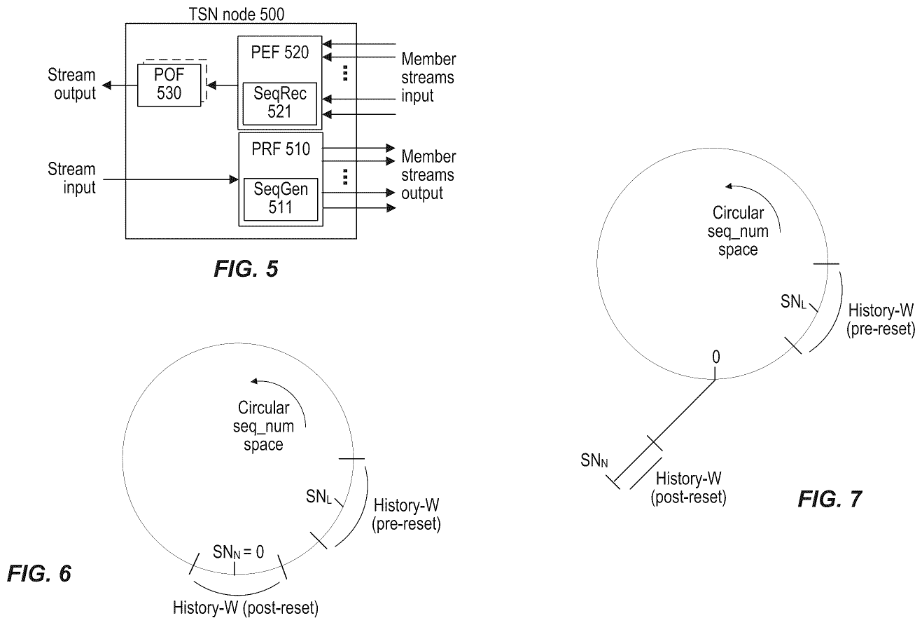

FIG. 5 is a block diagram of a TSN node according to various embodiments of the present disclosure. The TSN node (500) includes a PRF (510) that can perform replication of an input stream into multiple output member streams, and a PEF (520) that can rejoin multiple input member streams and eliminate duplicate packets to form an output stream. The output of the PEF is input to one or more instances of a POF (530), which perform(s) packet reordering according to various embodiments discussed below. PEF has its own states, such as History-W, TimeOut, etc.

The PRF shown in FIG. 5 also includes sequence number generator function (SeqGen 511), which generates sequence numbers for packets to be sent in the output member streams. The PEF shown in FIG. 5 includes a sequence number recovery function (SeqRec 521), which operates on packets passed up the protocol stack towards the higher layer functions and uses the seq_num parameter to decide which packets to pass and which to discard.

Although POF (530), PEF (520), and PRF (510) are shown as being part of a single TSN node in FIG. 5, these functions can also be implemented separately in a cloud computing arrangement, provided that necessary communication between these functions can be maintained.

SeqGen functions in conventional 802.1CB-2017 implementations utilize a single seq_num space for packet sequence numbers. This seq_num space is circular and the first packet after reset of the SeqGen function is sent with seq_num=0.

FIG. 6 shows an example of a circular seq_num space before and after reset of the SeqGen function. Before reset, SN_{L}>0 was the largest packet seq_num seen in the TSN/DetNet network, based on a pre-reset history window (History-W). After reset, SN_{N}=0 is the first packet seq_num based on a different History-W.

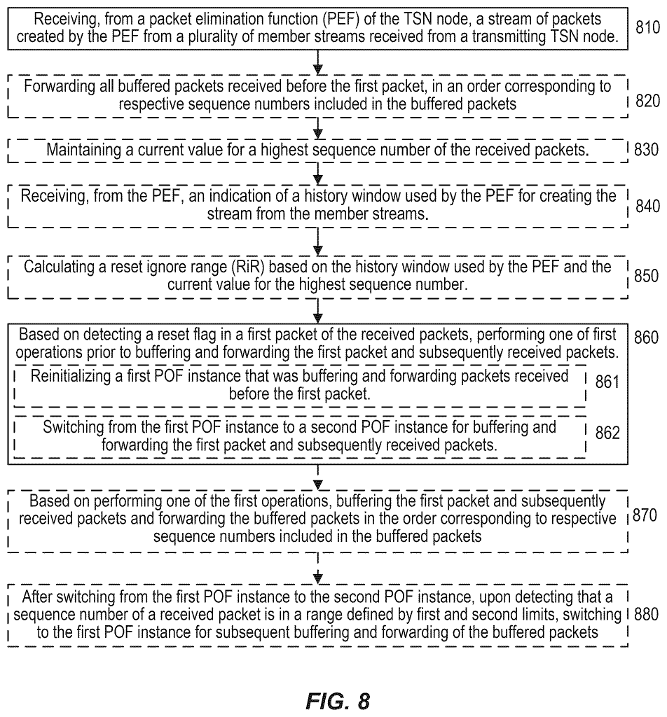

However, reset of the SeqGen function in a transmitting TSN node may cause pre-reset packets (i.e., sent before reset) and post-reset packets (i.e., sent after reset) to exist simultaneously in the TSN/DetNet network. In the context of FIG. 8, an after-reset packet with SN_{N}=0 may arrive at the input to POF before the pre-reset packet with SN_{L}>0.

As described above in relation to FIG. 3, POF compares seq_num values of arriving packets to POFLastSent to determine if any reordering is needed. Such a comparison works within the History-W when seq_num space is circular, as illustrated in FIG. 6. However, this operation can lead to packet drops in the above-mentioned scenario, i.e., when an after-reset packet with SN_{N}=0 arrives at POF before the pre-reset packet with SN_{L}>0.

The probability of unnecessary packet drop by POF after seq_num reset can be mitigated by providing POF with notice of the reset event via a “ResetFlag”, which is set in the first packet sent after a reset event. Using the “ResetFlag” allows fast and deterministic change of the History-W of the PEF functionality. All pre-reset packets outside of the new “after-reset History-Window” are dropped by PEF and they do not reach POF. Additionally, POF per-packet processing can be enhanced by adding the following logic:
IF “ResetFlag=set” AND “seq_num out of RiR”
   THEN
      Forward packets from POFBuffer according to their seq_num order.
      Place packet with ResetFlag=set in the POF Buffer and start POF_Initialization
   ELSE
      Normal POF operation

Note that RiR stands for Reset Ignore Range, which is packet sequence number range in which PEF ignores the received “SeqResetFlag” and checks the received packet against the actual History-W. In the above logic, POF also compares sequence number of the received packet against RiR. To perform this operation, POF must know “frerSeqRcvyHistoryLength”, a history window used by PEF to calculate RiR. During operation PEF checks the seq_num of arriving packets against “frerSeqRcvyHistoryLength” and discards any packets with a sequence number outside this window. Additionally, POF must store the highest sequence number received in “HighestSeenseq_num”, which it also uses to calculate RiR. Note that “HighestSeenseq_num” may be larger than “POFLastSent”, due to the possibility of out-of-order arrival of packets.

In the above-described embodiments, POF can be considered a single instance with some enhancements to conventional POF functionality. In other embodiments, multiple POF instances can be employed. In the seamless FRER/PREF arrangements described in WO2021/005397A1, WO2021/005400A1, and WO2021/0118910A1, the first packet after the reset of the sequence generation function is sent with “ResetFlag=set” and with a sequence number from the “Initseq_numSpace” (“InitSeqFlag=set”). In other words, the conventional circular sequence number space is used during normal operation and a linear sequence number space (Initseq_numSpace) is added to handle reset situations.

In these embodiments, different POF instances are used for the two types of sequence number spaces, i.e., InitPOF for the Initseq_numSpace and POF for the normal circular sequence number space. Each instance has its own variables and buffer. The selection between using InitPOF and POF instances is based on the “InitSeqFlag” in the packet.

FIG. 7 shows an example of this arrangement with two sequence number spaces, circular before reset of the SeqGen function and linear after reset of the SeqGen function. Before reset, SN_{L}>0 was the largest packet seq_num seen in the TSN/DetNet network, based on a pre-reset history window (History-W). After reset, SN_{N}=0 is the first packet seq_num based on a different History-W. The following logic describes operation of embodiments illustrated by FIG. 7, after POF/InitPOF is started in a node (BEGIN event or RESET_OF_POF event):
for both InitPOF and POF
   Set true the following variables: InitPOFTakeAny, POFTakeAny
   Erase the following buffers: InitBufferPOF, BufferPOF
First packet after BEGIN/RESET_OF_POF starts POF/InitPOF initialization (below). InitPOF instance/entity with linear sequence number space operates as follows:
Initialization of InitPOF for next packet (i.e., InitPOFTakeAny=True)
   take the first packet received,
   clear InitPOFTakeAny
   start initialization rules
      store packet in InitBuffer for POFMaxDelay,
      if delay timer of the first packet expires THEN
         send packet from InitBuffer with the lowest Initseq_num followed by packets with higher Initseq_num in increasing order of their seq_num until the packet with expired timer is forwarded
         continue with normal InitPOF operation
Normal InitPOF operation:
   Check InitPOFLastSent and send or store the packet
InitPOF operation for packets with ResetFlag set (and InitPOFTakeAny=False):
   IF “ResetFlag=set” AND “Initseq_num out of iRiR”.
      THEN
         Forward all stored packets from InitBuffer in the order of their Initseq_num.
         Place received packet with “ResetFlag=set” in InitBuffer and start initialization rules of InitPOF
      ELSE
         ignore ResetFlag and go with normal InitPOF operation
InitPOF operation for packets approaching the “normal sequence number space”:
   sets the “POFTakeAny” variable of the normal sequence number space if the “seq_num” of the packet is in the following range:

### {“GenSeqSpace”−“frerSeqRcvyHistoryLength” . . . “GenSeqSpace”−2×“frerSeqRcvyHistoryLength”}.

Note the above range shows that the new initial sequence number space is soon exhausted as it approaches the original sequence number space. As this occurs, POF is prepared to receive the first packet with sequence number in the normal sequence number space.

Also, note that iRiR stands for Initial Reset Ignore Range, which is the packet sequence number range in which PEF ignores the received “SeqResetFlag” and checks the received packet against the actual History-W. In the above logic, InitPOF also compares sequence number of the received packet against iRiR, in a similar manner as POF uses RiR in the embodiments described above. To perform this operation, InitPOF must know “frerSeqRcvyHistoryLength”, a history window used by PEF to calculate RiR. Additionally, InitPOF must store the highest sequence number received in “HighestSeenseq_num”, which it also uses to calculate iRiR. Note that “HighestSeenseq_num” may be larger than “POFLastSent”, due to the possibility of out-of-order arrival of packets.

POF instance/entity with circular sequence number space operates as follows:
Initialization of POF for next packet (i.e., POFTakeAny=True)
   take first packet,
   clear POFTakeAny
   start initialization rules
      store packet in Buffer for POFMaxDelay,
      if delay timer of the first packet expires:
         send packet from Buffer with the lowest seq_num and packets with higher seq_num until expired timer packet forwarded
         then continue with normal POF operation.
Normal POF operation:
   Check POFLastSent and send or store the packet.

These embodiments described above can be further illustrated with reference to FIG. 8, which depicts an exemplary method (e.g., procedure) performed by one or more instances of a packet ordering function (POF) for a time-sensitive network (TSN) node configured for frame replication and elimination for reliability (FRER). Put differently, various features and/or operations of the exemplary method described below correspond to various embodiments described above. Although the exemplary method is illustrated in FIG. 8 by specific blocks in a particular order, the operations corresponding to the blocks can be performed in a different order than shown and can be combined and/or divided into blocks having different functionality than shown. Optional blocks or operations are indicated by dashed lines.

Below the one or more POF instances will be referred to generically as POF instance(s), and more specifically as either single POF instance or first and second POF instances.

The exemplary method shown in FIG. 8 includes the operations of block 810, in which the POF instance(s) can receive, from a packet elimination function (PEF) of the TSN node, a stream of packets created by the PEF from a plurality of member streams received from a transmitting TSN node. FIG. 2 shows an example of n=2 member streams received via n=2 disjoint paths. The exemplary method also includes the operations of block 860, where based on detecting a reset flag in a first packet of the received packets, the POF instance(s) can perform one of the following first operations (labelled with corresponding sub-block numbers) prior to buffering and forwarding the first packet and subsequently received packets:
(861) reinitializing a first POF instance (e.g., “POF” described above) that was buffering and forwarding packets received before the first packet, or
(862) switching from the first POF instance to a second POF instance (e.g., “InitPOF” described above) for buffering and forwarding the first packet and subsequently received packets.

In some embodiments, the exemplary method can also include the operations of block 820, in which the POF instance(s) can forward all buffered packets received before the first packet, in an order corresponding to respective sequence numbers included in the buffered packets. Also, the exemplary method can also include the operations of block 870, where based on performing one of the first operations in block 860, the POF instance(s) can buffer the first packet and subsequently received packets and forward the buffered packets in the order corresponding to respective sequence numbers included in the buffered packets.

In some of these embodiments, reinitializing the first POF instance in sub-block 851 comprises starting a timer associated with the first POF instance upon detecting the reset flag in the first packet. In such case, buffering the first packet and subsequently received packets in block 870 is performed while the timer is running and forwarding the first packet and subsequently received packets in block 870 is performed upon expiration of the timer. FIG. 6 shows an example of these embodiments.

In other of these embodiments, switching from the first POF instance to the second POF in sub-block 852 comprises starting a timer associated with the second POF instance upon detecting the reset flag in the first packet. In such case, buffering the first packet and subsequently received packets in block 870 is performed while the timer is running, and forwarding the first packet and subsequently received packets in block 870 is performed upon expiration of the timer. FIG. 7 shows an example of these embodiments.

In some embodiments, the detected reset flag indicates a reset event in a sequence number generation function of the transmitting TSN node. In some embodiments, the exemplary method can also include the operations of block 830, where the POF instance(s) can maintain a current value for a highest sequence number contained in the received packets (e.g., “HighestSeenseq_num”).

In some of these embodiments, the exemplary method can also include the second operations of blocks 840-850, where the POF instance(s) can receive from the PEF an indication of a history window used by the PEF for creating the stream from the member streams and calculate a reset ignore range (RiR) based on the history window used by the PEF and the current value for the highest sequence number. In such case, performing one of the first operations in block 860 is further based on a sequence number of the first packet being outside of the RiR. Some exemplary logic for these operations was discussed above. In some variants of these embodiments, the current value for the highest sequence number is greater than the sequence number of the first packet.

In some variants of these embodiments, the first operation performed is switching from the first POF instance to the second POF instance in sub-block 862, the second operations are performed in blocks 840-850 by the second POF instance, and the reset flag is detected by the second POF instance. In some further variants, the first POF instance utilizes a circular sequence number space for the order of the forwarding and the second POF instance utilizes a linear sequence number space for the order of the forwarding. For example, the linear sequence number space starts at sequence number zero. FIG. 7 shows a specific example of these variants.

In some further variants, the exemplary method can also include the operations of block 870, where after switching from the first POF instance to the second POF instance in sub-block 862, upon detecting that a sequence number of a received packet is in a range defined by first and second limits, the POF instance(s) can switch to the first POF instance for subsequent buffering and forwarding of the buffered packets. For example, the first limit is a first integer multiple of a history window used by the PEF for creating the stream from the member streams, and the second limit is a second integer multiple of the history window. As a more specific example, the first integer is one and the second integer is two, which corresponds to the integer multiples of “frerSeqRcvyHistoryLength” discussed above.

In other variants of these embodiments, the first operation performed is reinitializing the first POF instance in sub-block 861, the second operations are performed in blocks 840-850 by the first POF instance, and the reset flag is detected by the first POF instance. In some further variants, the first POF instance utilizes a circular sequence number space for the order of forwarding. FIG. 6 shows a specific example of these variants.

Although various embodiments are described herein above in terms of methods, apparatus, devices, computer-readable medium and receivers, the person of ordinary skill will readily comprehend that such methods can be embodied by various combinations of hardware and software in various systems, communication devices, computing devices, control devices, apparatuses, non-transitory computer-readable media, etc.

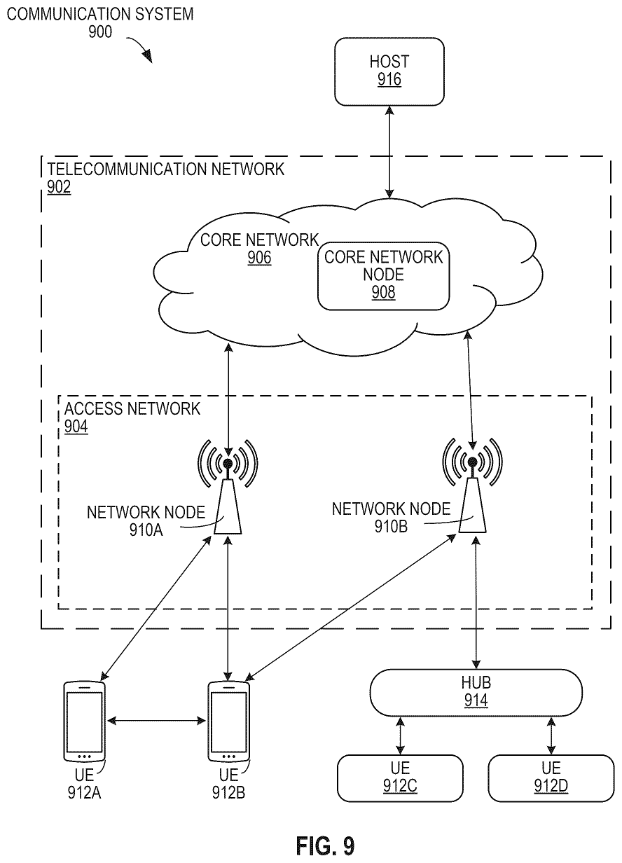

FIG. 9 shows an example of a communication system 900 in accordance with some embodiments. In the example, communication system 900 includes a telecommunication network 902 that includes an access network 904 (e.g., RAN) and a core network 906, which includes one or more core network nodes 908. Access network 904 includes one or more access network nodes, such as network nodes 910a-b (one or more of which may be generally referred to as network nodes 910), or any other similar 3GPP access node or non-3GPP access point. Network nodes 910 facilitate direct or indirect connection of user equipment (UE), such as by connecting UEs 912a-d (one or more of which may be generally referred to as UEs 912) to the core network 906 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, communication system 900 may include any number of wired or wireless networks, network nodes, UEs, and/or any other components or systems that may facilitate or participate in the communication of data and/or signals whether via wired or wireless connections. Communication system 900 may include and/or interface with any type of communication, telecommunication, data, cellular, radio network, and/or other similar type of system.

UEs 912 may be any of a wide variety of communication devices, including wireless devices arranged, configured, and/or operable to communicate wirelessly with network nodes 910 and other communication devices. Similarly, network nodes 910 are arranged, capable, configured, and/or operable to communicate directly or indirectly with UEs 912 and/or with other network nodes or equipment in telecommunication network 902 to enable and/or provide network access, such as wireless network access, and/or to perform other functions, such as administration in telecommunication network 902.

In the depicted example, the core network 906 connects network nodes 910 to one or more hosts, such as host 916. These connections may be direct or indirect via one or more intermediary networks or devices. In other examples, network nodes may be directly coupled to hosts. The core network 906 includes one or more core network nodes (e.g., 908) that are structured with hardware and software components. Features of these components may be substantially similar to those described with respect to the UEs, network nodes, and/or hosts, such that the descriptions thereof are generally applicable to the corresponding components of core network node 908. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

Host 916 may be under the ownership or control of a service provider other than an operator or provider of access network 904 and/or telecommunication network 902, and may be operated by the service provider or on behalf of the service provider. Host 916 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, communication system 900 of FIG. 9 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, telecommunication network 902 is a cellular network that implements 3GPP standardized features. Accordingly, telecommunication network 902 may support network slicing to provide different logical networks to different devices that are connected to telecommunication network 902. For example, telecommunication network 902 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, UEs 912 are configured to transmit and/or receive information without direct human interaction. For instance, a UE may be designed to transmit information to access network 904 on a predetermined schedule, when triggered by an internal or external event, or in response to requests from access network 904. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio—Dual Connectivity (EN-DC).

In the example, hub 914 communicates with access network 904 to facilitate indirect communication between one or more UEs (e.g., 912c and/or 912d) and network nodes (e.g., 910b). In some examples, hub 914 may be a controller, router, content source and analytics, or any of the other communication devices described herein regarding UEs. For example, hub 914 may be a broadband router enabling access to the core network 906 for the UEs. As another example, hub 914 may be a controller that sends commands or instructions to one or more actuators in the UEs. Commands or instructions may be received from the UEs, network nodes 910, or by executable code, script, process, or other instructions in hub 914. As another example, hub 914 may be a data collector that acts as temporary storage for UE data and, in some embodiments, may perform analysis or other processing of the data. As another example, hub 914 may be a content source. For example, for a UE that is a VR headset, display, loudspeaker or other media delivery device, hub 914 may retrieve VR assets, video, audio, or other media or data related to sensory information via a network node, which hub 914 then provides to the UE either directly, after performing local processing, and/or after adding additional local content. In still another example, hub 914 acts as a proxy server or orchestrator for the UEs, in particular in if one or more of the UEs are low energy IoT devices.

Hub 914 may have a constant/persistent or intermittent connection to network node 910b. Hub 914 may also allow for a different communication scheme and/or schedule between hub 914 and UEs (e.g., UE 912c and/or 912d), and between hub 914 and the core network 906. In other examples, hub 914 is connected to the core network 906 and/or one or more UEs via a wired connection. Moreover, hub 914 may be configured to connect to an M2M service provider over access network 904 and/or to another UE over a direct connection. In some scenarios, UEs may establish a wireless connection with network nodes 910 while still connected via hub 914 via a wired or wireless connection. In some embodiments, hub 914 may be a dedicated hub—that is, a hub whose primary function is to route communications to/from the UEs from/to network node 910b. In other embodiments, hub 914 may be a non-dedicated hub—that is, a device which is capable of operating to route communications between the UEs and network node 910b, but which is additionally capable of operating as a communication start and/or end point for certain data channels.

In various embodiments, one or more of host 916, core network node 908, network node 910, hub 914, and UE 912 can be configured as a TSN node capable of performing various exemplary methods (e.g., procedures) described above.

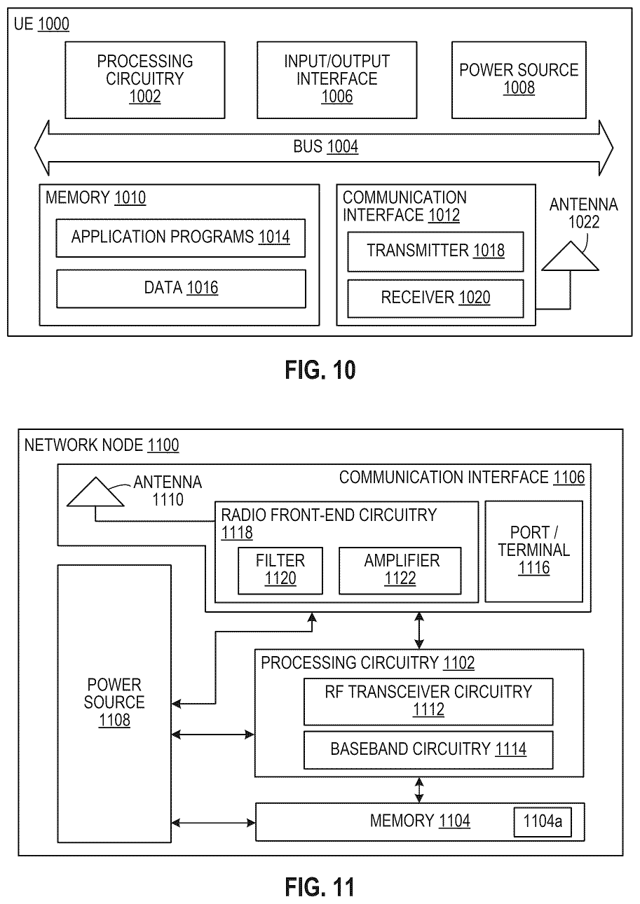

FIG. 10 shows a UE 1000 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by 3GPP, including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

UE 1000 includes processing circuitry 1002 that is operatively coupled via a bus 1004 to an input/output interface 1006, a power source 1008, a memory 1010, a communication interface 1012, and/or any other component, or any combination thereof. Certain UEs may utilize all or a subset of the components shown in FIG. 10. The level of integration between the components may vary from one UE to another UE. Further, certain UEs may contain multiple instances of a component, such as multiple processors, memories, transceivers, transmitters, receivers, etc.

Processing circuitry 1002 is configured to process instructions and data and may be configured to implement any sequential state machine operative to execute instructions stored as machine-readable computer programs in memory 1010. Processing circuitry 1002 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, processing circuitry 1002 may include multiple central processing units (CPUs).

In the example, input/output interface 1006 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into UE 1000. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, power source 1008 is structured as a battery or battery pack. Other types of power sources, such as an external power source (e.g., an electricity outlet), photovoltaic device, or power cell, may be used. Power source 1008 may further include power circuitry for delivering power from power source 1008 itself, and/or an external power source, to the various parts of UE 1000 via input circuitry or an interface such as an electrical power cable. Delivering power may be, for example, for charging of power source 1008. Power circuitry may perform any formatting, converting, or other modification to the power from power source 1008 to make the power suitable for the respective components of UE 1000 to which power is supplied.

Memory 1010 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, memory 1010 includes one or more application programs 1014, such as an operating system, web browser application, a widget, gadget engine, or other application, and corresponding data 1016. Memory 1010 may store, for use by UE 1000, any of a variety of various operating systems or combinations of operating systems.

Memory 1010 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ Memory 1010 may allow UE 1000 to access instructions, application programs and the like, stored on transitory or non-transitory memory media, to off-load data, or to upload data. An article of manufacture, such as one utilizing a communication system may be tangibly embodied as or in memory 1010, which may be or comprise a device-readable storage medium.

Processing circuitry 1002 may be configured to communicate with an access network or other network using communication interface 1012. Communication interface 1012 may comprise one or more communication subsystems and may include or be communicatively coupled to an antenna 1022. Communication interface 1012 may include one or more transceivers used to communicate, such as by communicating with one or more remote transceivers of another device capable of wireless communication (e.g., another UE or a network node in an access network). Each transceiver may include transmitter 1018 and/or receiver 1020 appropriate to provide network communications (e.g., optical, electrical, frequency allocations, and so forth). Moreover, transmitter 1018 and receiver 1020 may be coupled to one or more antennas (e.g., 1022) and may share circuit components, software or firmware, or alternatively be implemented separately.

In the illustrated embodiment, communication functions of communication interface 1012 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1012, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to UE 1000 shown in FIG. 10.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

In some embodiments, UE 1000 can be configured as a TSN node capable of performing various exemplary methods (e.g., procedures) described above.

FIG. 11 shows a network node 1100 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (e.g., radio access points) and base stations (e.g., radio base stations, Node Bs, eNBs, and gNBs).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

Network node 1100 includes processing circuitry 1102, memory 1104, communication interface 1106, and power source 1108. Network node 1100 may be composed of multiple physically separate components (e.g., a NodeB component and a RNC component, or a BTS component and a BSC component, etc.), which may each have their own respective components. In certain scenarios in which network node 1100 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, network node 1100 may be configured to support multiple radio access technologies (RATs). In such embodiments, some components may be duplicated (e.g., separate memory 1104 for different RATs) and some components may be reused (e.g., a same antenna 1110 may be shared by different RATs). Network node 1100 may also include multiple sets of the various illustrated components for different wireless technologies integrated into network node 1100, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1100.

Processing circuitry 1102 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1100 components, such as memory 1104, to provide network node 1100 functionality.

In some embodiments, processing circuitry 1102 includes a system on a chip (SOC). In some embodiments, processing circuitry 1102 includes one or more of radio frequency (RF) transceiver circuitry 1112 and baseband processing circuitry 1114. In some embodiments, radio RF transceiver circuitry 1112 and baseband processing circuitry 1114 may be on separate chips (or sets of chips), boards, or units, such as radio units and digital units. In alternative embodiments, part or all of RF transceiver circuitry 1112 and baseband processing circuitry 1114 may be on the same chip or set of chips, boards, or units.

Memory 1104 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by processing circuitry 1102. Memory 1104 may store any suitable instructions, data, or information, including a computer program, software, an application including one or more of logic, rules, code, tables, and/or other instructions capable of being executed by processing circuitry 1102 and utilized by network node 1100. Memory 1104 may be used to store any calculations made by processing circuitry 1102 and/or any data received via communication interface 1106. In some embodiments, processing circuitry 1102 and memory 1104 is integrated.

Communication interface 1106 is used in wired or wireless communication of signaling and/or data between a network node, access network, and/or UE. As illustrated, communication interface 1106 comprises port(s)/terminal(s) 1116 to send and receive data, for example to and from a network over a wired connection. Communication interface 1106 also includes radio front-end circuitry 1118 that may be coupled to, or in certain embodiments a part of, antenna 1110. Radio front-end circuitry 1118 comprises filters 1120 and amplifiers 1122. Radio front-end circuitry 1118 may be connected to an antenna 1110 and processing circuitry 1102. The radio front-end circuitry may be configured to condition signals communicated between antenna 1110 and processing circuitry 1102. Radio front-end circuitry 1118 may receive digital data that is to be sent out to other network nodes or UEs via a wireless connection. Radio front-end circuitry 1118 may convert the digital data into a radio signal having the appropriate channel and bandwidth parameters using a combination of filters 1120 and/or amplifiers 1122. The radio signal may then be transmitted via antenna 1110. Similarly, when receiving data, antenna 1110 may collect radio signals which are then converted into digital data by radio front-end circuitry 1118. The digital data may be passed to processing circuitry 1102. In other embodiments, the communication interface may comprise different components and/or different combinations of components.

In certain alternative embodiments, network node 1100 does not include separate radio front-end circuitry 1118, instead, processing circuitry 1102 includes radio front-end circuitry and is connected to antenna 1110. Similarly, in some embodiments, all or some of RF transceiver circuitry 1112 is part of communication interface 1106. In still other embodiments, communication interface 1106 includes one or more ports or terminals 1116, radio front-end circuitry 1118, and RF transceiver circuitry 1112, as part of a radio unit (not shown), and communication interface 1106 communicates with baseband processing circuitry 1114, which is part of a digital unit (not shown).

Antenna 1110 may include one or more antennas, or antenna arrays, configured to send and/or receive wireless signals. Antenna 1110 may be coupled to radio front-end circuitry 1118 and may be any type of antenna capable of transmitting and receiving data and/or signals wirelessly. In certain embodiments, antenna 1110 is separate from network node 1100 and connectable to network node 1100 through an interface or port.

Antenna 1110, communication interface 1106, and/or processing circuitry 1102 may be configured to perform any receiving operations and/or certain obtaining operations described herein as being performed by the network node. Any information, data and/or signals may be received from a UE, another network node and/or any other network equipment. Similarly, antenna 1110, communication interface 1106, and/or processing circuitry 1102 may be configured to perform any transmitting operations described herein as being performed by the network node. Any information, data and/or signals may be transmitted to a UE, another network node and/or any other network equipment.

Power source 1108 provides power to the various components of network node 1100 in a form suitable for the respective components (e.g., at a voltage and current level needed for each respective component). Power source 1108 may further comprise, or be coupled to, power management circuitry to supply the components of network node 1100 with power for performing the functionality described herein. For example, network node 1100 may be connectable to an external power source (e.g., the power grid, an electricity outlet) via an input circuitry or interface such as an electrical cable, whereby the external power source supplies power to power circuitry of power source 1108. As a further example, power source 1108 may comprise a source of power in the form of a battery or battery pack which is connected to, or integrated in, power circuitry. The battery may provide backup power should the external power source fail.

Embodiments of network node 1100 may include additional components beyond those shown in FIG. 11 for providing certain aspects of the network node's functionality, including any of the functionality described herein and/or any functionality necessary to support the subject matter described herein. For example, network node 1100 may include user interface equipment to allow input of information into network node 1100 and to allow output of information from network node 1100. This may allow a user to perform diagnostic, maintenance, repair, and other administrative functions for network node 1100.

In some embodiments, network node 1100 can be configured as a TSN node capable of performing various exemplary methods (e.g., procedures) described above.

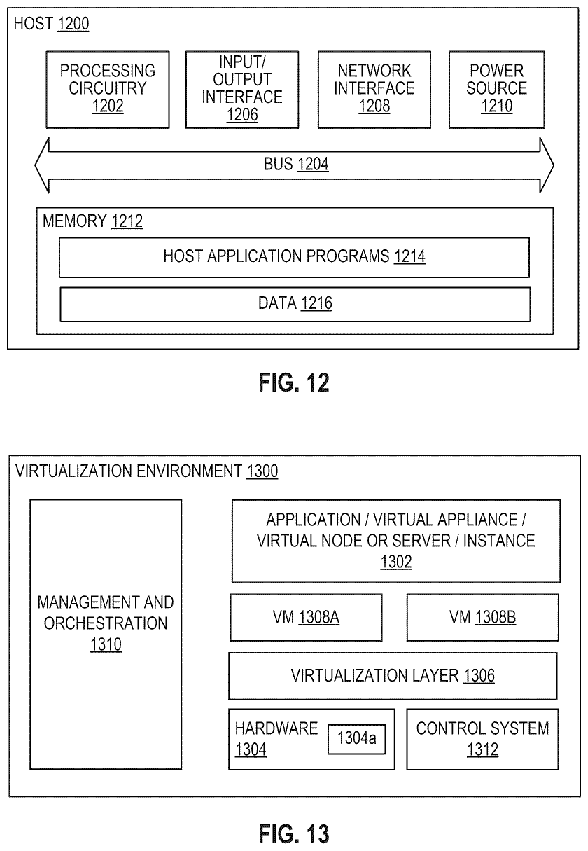

FIG. 12 is a block diagram of a host 1200, which may be an embodiment of host 916 of FIG. 9, in accordance with various aspects described herein. As used herein, host 1200 may be or comprise various combinations hardware and/or software, including a standalone server, a blade server, a cloud-implemented server, a distributed server, a virtual machine, container, or processing resources in a server farm. Host 1200 may provide one or more services to one or more UEs.

Host 1200 includes processing circuitry 1202 that is operatively coupled via bus 1204 to input/output interface 1206, network interface 1208, power source 1210, and memory 1212. Other components may be included in other embodiments. Features of these components may be substantially similar to those described with respect to the devices of previous figures, such as FIGS. 10 and 11, such that the descriptions thereof are generally applicable to the corresponding components of host 1200.

Memory 1212 may include one or more computer programs including one or more host application programs 1214 and data 1216, which may include user data, e.g., data generated by a UE for host 1200 or data generated by host 1200 for a UE. Embodiments of host 1200 may utilize only a subset or all of the components shown. Host application programs 1214 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). Host application programs 1214 may also provide for user authentication and licensing checks and may periodically report health, routes, and content availability to a central node, such as a device in or on the edge of a core network. Accordingly, host 1200 may select and/or indicate a different host for over-the-top services for a UE. Host application programs 1214 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

In some embodiments, host 1200 can be configured as a TSN node capable of performing various exemplary methods (e.g., procedures) described above.

FIG. 13 is a block diagram illustrating a virtualization environment 1300 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1300 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1302 (which may alternatively be called software instances, virtual appliances, network functions, virtual nodes, virtual network functions, etc.) are run in the virtualization environment 1300 to implement some of the features, functions, and/or benefits of some of the embodiments disclosed herein.

In some embodiments, one or more TSN nodes capable of performing various exemplary methods (e.g., procedures) described above can be hosted by virtualization environment 1300, e.g., as respective virtual nodes 1302.

Hardware 1304 includes processing circuitry, memory that stores software and/or instructions executable by hardware processing circuitry, and/or other hardware devices as described herein, such as a network interface, input/output interface, and so forth. Software may be executed by processing circuitry to instantiate one or more virtualization layers 1306 (also referred to as hypervisors or virtual machine monitors (VMMs)), provide VMs 1308a-b (one or more of which may be generally referred to as VMs 1308), and/or perform any of the functions, features and/or benefits described in relation with some embodiments described herein. The virtualization layer 1306 may present a virtual operating platform that appears like networking hardware to VMs 1308.

VMs 1308 comprise virtual processing, virtual memory, virtual networking or interface and virtual storage, and may be run by a corresponding virtualization layer 1306. Different embodiments of the instance of a virtual appliance 1302 may be implemented on one or more of VMs 1308, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, each VM 1308 may be a software implementation of a physical machine that runs programs as if they were executing on a physical, non-virtualized machine. Each VM 1308, and that part of hardware 1304 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1308 on top of the hardware 1304 and corresponds to application 1302.

Hardware 1304 may be implemented in a standalone network node with generic or specific components. Hardware 1304 may implement some functions via virtualization. Alternatively, hardware 1304 may be part of a larger cluster of hardware (e.g., such as in a data center or CPE) where many hardware nodes work together and are managed via management and orchestration 1310, which, among others, oversees lifecycle management of applications 1302. In some embodiments, hardware 1304 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1312 which may alternatively be used for communication between hardware nodes and radio units.

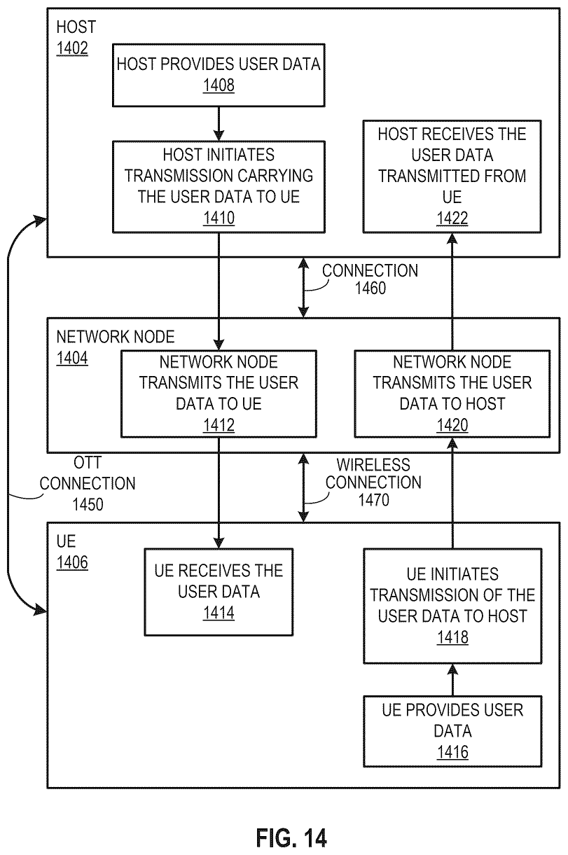

FIG. 14 shows a communication diagram of a host 1402 communicating via a network node 1404 with a UE 1406 over a partially wireless connection in accordance with some embodiments. Example implementations, in accordance with various embodiments, of the UE (such as a UE 912a of FIG. 9 and/or UE 1000 of FIG. 10), network node (such as network node 910a of FIG. 9 and/or network node 1100 of FIG. 11), and host (such as host 916 of FIG. 9 and/or host 1200 of FIG. 12) discussed in the preceding paragraphs will now be described with reference to FIG. 14.

Like host 1200, embodiments of host 1402 include hardware, such as a communication interface, processing circuitry, and memory. Host 1402 also includes software, which is stored in or accessible by host 1402 and executable by processing circuitry. The software includes a host application that may be operable to provide a service to a remote user, such as UE 1406 connecting via an over-the-top (OTT) connection 1450 extending between UE 1406 and host 1402. In providing the service to the remote user, a host application may provide user data which is transmitted using OTT connection 1450.

Network node 1404 includes hardware enabling it to communicate with host 1402 and UE 1406. Connection 1460 may be direct or pass through a core network (like core network 906 of FIG. 9) and/or one or more other intermediate networks, such as one or more public, private, or hosted networks. For example, an intermediate network may be a backbone network or the Internet.

UE 1406 includes hardware and software, which is stored in or accessible by UE 1406 and executable by the UE's processing circuitry. The software includes a client application, such as a web browser or operator-specific “app” that may be operable to provide a service to a human or non-human user via UE 1406 with the support of host 1402. In host 1402, an executing host application may communicate with the executing client application via OTT connection 1450 terminating at UE 1406 and host 1402. In providing the service to the user, the UE's client application may receive request data from the host's host application and provide user data in response to the request data. OTT connection 1450 may transfer both the request data and the user data. The UE's client application may interact with the user to generate the user data that it provides to the host application through OTT connection 1450.

OTT connection 1450 may extend via a connection 1460 between host 1402 and network node 1404 and via a wireless connection 1470 between network node 1404 and UE 1406 to provide the connection between host 1402 and UE 1406. Connection 1460 and wireless connection 1470, over which OTT connection 1450 may be provided, have been drawn abstractly to illustrate the communication between host 1402 and UE 1406 via network node 1404, without explicit reference to any intermediary devices and the precise routing of messages via these devices.

As an example of transmitting data via OTT connection 1450, in step 1408, host 1402 provides user data, which may be performed by executing a host application. In some embodiments, the user data is associated with a particular human user interacting with UE 1406. In other embodiments, the user data is associated with a UE 1406 that shares data with host 1402 without explicit human interaction. In step 1410, host 1402 initiates a transmission carrying the user data towards UE 1406. Host 1402 may initiate the transmission responsive to a request transmitted by UE 1406. The request may be caused by human interaction with UE 1406 or by operation of the client application executing on UE 1406. The transmission may pass via network node 1404, in accordance with the teachings of the embodiments described throughout this disclosure. Accordingly, in step 1412, network node 1404 transmits to UE 1406 the user data that was carried in the transmission that host 1402 initiated, in accordance with the teachings of the embodiments described throughout this disclosure. In step 1414, UE 1406 receives the user data carried in the transmission, which may be performed by a client application executed on UE 1406 associated with the host application executed by host 1402.

In some examples, UE 1406 executes a client application which provides user data to host 1402. The user data may be provided in reaction or response to the data received from host 1402. Accordingly, in step 1416, UE 1406 may provide user data, which may be performed by executing the client application. In providing the user data, the client application may further consider user input received from the user via an input/output interface of UE 1406. Regardless of the specific manner in which the user data was provided, UE 1406 initiates, in step 1418, transmission of the user data towards host 1402 via network node 1404. In step 1420, in accordance with the teachings of the embodiments described throughout this disclosure, network node 1404 receives user data from UE 1406 and initiates transmission of the received user data towards host 1402. In step 1422, host 1402 receives the user data carried in the transmission initiated by UE 1406.

In various embodiments, one or more of host 1402, network node 1404, and UE 1408 can be configured as a TSN node capable of performing various exemplary methods (e.g., procedures) described above.

One or more of the various embodiments improve the performance of OTT services provided to UE 1406 using OTT connection 1450, in which wireless connection 1470 forms the last segment. More precisely, embodiments can ensure packet ordering (e.g., by a POF) works correctly in TSN/DetNet deployments in which seamless FRER/PREF functionality is also used, even after reset of a packet sequence number generator in a transmitting TSN node. By improving TSN/DetNet reliability in this manner, embodiments increase the value of OTT services delivered over such networks to both end users and service providers.

In an example scenario, factory status information may be collected and analyzed by host 1402. As another example, host 1402 may process audio and video data which may have been retrieved from a UE for use in creating maps. As another example, host 1402 may collect and analyze real-time data to assist in controlling vehicle congestion (e.g., controlling traffic lights). As another example, host 1402 may store surveillance video uploaded by a UE. As another example, host 1402 may store or control access to media content such as video, audio, VR or AR which it can broadcast, multicast or unicast to UEs. As other examples, host 1402 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring OTT connection 1450 between host 1402 and UE 1406, in response to variations in the measurement results. The measurement procedure and/or the network functionality for reconfiguring the OTT connection may be implemented in software and hardware of host 1402 and/or UE 1406. In some embodiments, sensors (not shown) may be deployed in or in association with other devices through which OTT connection 1450 passes; the sensors may participate in the measurement procedure by supplying values of the monitored quantities exemplified above, or supplying values of other physical quantities from which software may compute or estimate the monitored quantities. The reconfiguring of OTT connection 1450 may include message format, retransmission settings, preferred routing etc.; the reconfiguring need not directly alter the operation of network node 1404. Such procedures and functionalities may be known and practiced in the art. In certain embodiments, measurements may involve proprietary UE signaling that facilitates measurements of throughput, propagation times, latency and the like, by host 1402. The measurements may be implemented in that software causes messages to be transmitted, in particular empty or ‘dummy’ messages, using OTT connection 1450 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. Processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, processing circuitry may be used to cause the respective functional unit to perform corresponding functions according to one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously.

Embodiments of the techniques and apparatus described herein also include, but are not limited to, the following enumerated examples:
A1. A method performed by one or more instances of a packet ordering function (POF) for a time-sensitive network (TSN) node configured for frame replication and elimination for reliability (FRER), the method comprising:
   receiving, from a packet elimination function (PEF) of the TSN node, a stream of packets created by the PEF from a plurality of member streams received from a transmitting TSN node;
   buffering the received packets and forwarding the buffered packets in an order corresponding to respective sequence numbers included in the buffered packets;
   detecting a reset event in a sequence number generation function of the transmitting TSN node; and
   performing one of the following first operations based on detecting the reset event:
      initializing a single POF instance for subsequent forwarding of the buffered packets, or
      switching from a first POF instance to second POF instance for subsequent forwarding of the buffered packets.
A2. The method of embodiment A1, wherein detecting the reset event comprises detecting a reset flag in a first packet of the received packets.
A2a. The method of embodiment A2, wherein buffering the received packets comprises maintaining a current value for a highest sequence number of the received packets.
A3. The method of embodiment A2a, further comprising the following second operations:
   receiving, from the PEF, an indication of a history window used by the PEF for creating the stream from the member streams;
   calculating a reset ignore range (RiR) based on the history window used by the PEF and the current value for the highest sequence number;
   wherein performing one of the first operations is further based on a sequence number of the first packet being outside of the RiR.
A4. The method of embodiment A3, wherein the current value for the highest sequence number is greater than the sequence number of the first packet.
A5. The method of any of embodiments A3-A4, wherein:
   buffering and forwarding before detecting the reset event is performed by a first POF instance,
   the second operations are performed by a second POF instance,
   the reset flag is detected by the second POF instance, and
   buffering and forwarding after detecting the reset event is performed by the second POF instance.
A6. The method of any of embodiments A1-A5, wherein the first POF instance utilizes a circular sequence number space for the order of forwarding and the second POF instance utilizes a linear sequence number space for the order of forwarding.
A7. The method of embodiment A6, wherein the linear sequence number space starts at sequence number zero.
A8. The method of any of embodiments A6-A7, further comprising, while the second POF buffers and forwards after detecting the reset event, when a sequence number of a received packet is detected between first and second limits, switching to the first POF instance for subsequent buffering and forwarding of the buffered packets.
A9. The method of embodiment A8, wherein the first limit is a first integer multiple of a history window used by the PEF for creating the stream from the member streams, and the second limit is a second integer multiple of the history window.
A10. The method of embodiment A9, wherein the first integer is one and the second integer is two.
A11. The method of any of embodiments A3-A4, wherein:
   the reset flag is detected by a single POF instance,
   the second operations are performed by the single POF instance, and
   the buffered packet are forwarded by the single POF instance before and after detecting the reset event.
A12. The method of embodiment A11, wherein the single POF instance utilizes a circular sequence number space for the order of forwarding.
A13. The method of any of embodiments A11-A12, wherein buffering the received packets and forwarding the buffered packets after detecting the reset event comprises:
   forwarding all buffered packets received before the first packet, in the order corresponding to respective sequence numbers; and
   after initializing the single POF instance, buffering the first packet and subsequently received packets and forwarding the buffered packets in the order corresponding to respective sequence numbers.
B1. A time-sensitive network (TSN) node configured for frame replication and elimination for reliability (FRER) and with one or more instances of a packet ordering function (POF), the TSN node comprising:
   communication interface circuitry configured to communicate with one or more other TSN nodes; and
   processing circuitry operably coupled to the communication interface circuitry, whereby processing circuitry and the communication interface circuitry are configured to perform operations corresponding to any of the methods of embodiments A1-A13.
B2. A time-sensitive network (TSN) node configured for frame replication and elimination for reliability (FRER) and with one or more instances of a packet ordering function (POF), the TSN node being further configured to perform operations corresponding to any of the methods of embodiments A1-A13.
B3. A non-transitory, computer-readable medium storing program instructions that, when executed by processing circuitry of a time-sensitive network (TSN) node configured for frame replication and elimination for reliability (FRER) and with one or more instances of a packet ordering function (POF), configure the TSN node to perform operations corresponding to any of the methods of embodiments A1-A13.
B4. A computer program product comprising program instructions that, when executed by processing circuitry of a time-sensitive network (TSN) node configured for frame replication and elimination for reliability (FRER) and with one or more instances of a packet ordering function (POF), configure the TSN node to perform operations corresponding to any of the methods of embodiments A1-A13.

1. A method performed by one or more instances of a packet ordering function, POF, for a time-sensitive network, TSN, node configured for frame replication and elimination for reliability, FRER, the method comprising:
receiving, from a packet elimination function, PEF, of the TSN node, a stream of packets created by the PEF from a plurality of member streams received from a transmitting TSN node; and
based on detecting a reset flag in a first packet of the received packets, performing one of the following first operations prior to buffering and forwarding the first packet and subsequently received packets:
reinitializing a first POF instance that was buffering and forwarding packets received before the first packet, or
switching from the first POF instance to a second POF instance for buffering and forwarding the first packet and subsequently received packets.

2. The method of claim 1, further comprising:
forwarding all buffered packets received before the first packet, in an order corresponding to respective sequence numbers included in the buffered packets; and
based on performing one of the first operations, buffering the first packet and subsequently received packets and forwarding the buffered packets in the order corresponding to respective sequence numbers included in the buffered packets.

3. The method of claim 2, wherein:
reinitializing the first POF instance comprises starting a timer associated with the first POF instance upon detecting the reset flag in the first packet;
buffering the first packet and subsequently received packets is performed while the timer is running; and
forwarding the first packet and subsequently received packets is performed upon expiration of the timer.

4. The method of claim 2, wherein:
switching from the first POF instance to the second POF comprises starting a timer associated with the second POF instance upon detecting the reset flag in the first packet;
buffering the first packet and subsequently received packets is performed while the timer is running; and
forwarding the first packet and subsequently received packets is performed upon expiration of the timer.

5. The method of claim 1, wherein the detected reset flag indicates a reset event in a sequence number generation function of the transmitting TSN node.

6. The method of claim 1, further comprising maintaining a current value for a highest sequence number contained in the received packets.

7. The method of claim 6, further comprising the following second operations:
receiving from the PEF an indication of a history window used by the PEF for creating the stream from the member streams; and
calculating a reset ignore range, RiR, based on the history window used by the PEF and on the current value for the highest sequence number,
wherein performing one of the first operations is further based on a sequence number of the first packet being outside of the RiR.

8. The method of claim 7, wherein the current value for the highest sequence number is greater than the sequence number of the first packet.

9. The method of claim 7, wherein:
the first operation performed is switching from the first POF instance to the second POF instance; and
the second operations are performed by the second POF instance and the reset flag is detected by the second POF instance.

10. The method of claim 9, further comprising, after switching from the first POF instance to the second POF instance, upon detecting that a sequence number of a received packet is in a range defined by first and second limits, switching to the first POF instance for subsequent buffering and forwarding of the buffered packets.

11. The method of claim 10, wherein the first limit is a first integer multiple of a history window used by the PEF for creating the stream from the member streams, and the second limit is a second integer multiple of the history window.

12. The method of claim 11, wherein the first integer is one and the second integer is two.

13. The method of claim 9, wherein the first POF instance utilizes a circular sequence number space for the order of the forwarding and the second POF instance utilizes a linear sequence number space for the order of the forwarding.

14. The method of claim 13, wherein the linear sequence number space starts at sequence number zero.

15. The method of claim 7, wherein:
the first operation performed is reinitializing the first POF instance; and
the second operations are performed by the first POF instance and the reset flag is detected by the first POF instance.

16. The method of claim 15, wherein the first POF instance utilizes a circular sequence number space for the order of forwarding.

17. A time-sensitive network, TSN, node configured for frame replication and elimination for reliability, FRER, and with one or more instances of a packet ordering function, POF, the TSN node comprising:
communication interface circuitry configured to communicate with one or more other TSN nodes; and
processing circuitry operably coupled to the communication interface circuitry, whereby the processing circuitry and the communication interface circuitry are configured to:
receive, by a first POF instance of the TSN node, a stream of packets created by a packet elimination function, PEF, of the TSN node from a plurality of member streams received from a transmitting TSN node; and
based on detecting a reset flag in a first packet of the received packets, perform one of the following first operations prior to buffering and forwarding the first packet and subsequently received packets:
reinitialize the first POF instance, which was buffering and forwarding packets received before the first packet, or
switch from the first POF instance to a second POF instance for buffering and forwarding the first packet and subsequently received packets.

18. (canceled)

19. A time-sensitive network, TSN, node configured for frame replication and elimination for reliability, FRER, and with one or more instances of a packet ordering function, POF, the TSN node being further configured to:
receive, by a first POF instance of the TSN node, a stream of packets created by a packet elimination function, PEF, of the TSN node from a plurality of member streams received from a transmitting TSN node; and
based on detecting a reset flag in a first packet of the received packets, perform one of the following first operations prior to buffering and forwarding the first packet and subsequently received packets:
reinitialize the first POF instance, which was buffering and forwarding packets received before the first packet, or
switch from the first POF instance to a second POF instance for buffering and forwarding the first packet and subsequently received packets.

20. (canceled)

21. A non-transitory, computer-readable medium storing program instructions that, when executed by processing circuitry of a time-sensitive network, TSN, node configured for frame replication and elimination for reliability, FRER, and with one or more instances of a packet ordering function, POF, configure the TSN node to perform the method of claim 1.

22. (canceled)
